(19) United States
(12) Patent Application Publication
(10) Pub. No.: US 2008/0066192 A1
(43) Pub. Date: Mar. 13, 2008

(54) KEYLESS COPY OF ENCRYPTED DATA

(75) Inventors: Paul Merrill Greco, Tucson, AZ (US); Glen Alan Jaquette, Tucson, AZ (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(73) Assignee: INTERNATIONAL BUSINESS MACHINES CORPORATION, Armonk, NY (US)

(21) Appl. No.: 11/530,008

(22) Filed: Sep. 7, 2006

(51) Int. Cl. G06F 17/30

(52) U.S. Cl. 726/32

(57) ABSTRACT

Provided are techniques for copying data. Encrypted data from a first data storage medium is identified. A raw read of encrypted data from the first data storage medium is performed without decrypting the encrypted data. A raw write of the encrypted data to a second data storage medium is performed without again encrypting the encrypted data.

### BACKGROUND

1. Field

Embodiments of the invention relate to copying of encrypted data without the use of any secret key, which may also be referred as keyless copy of encrypted data.

2. Description of the Related Art

Automated data storage libraries (e.g. tape libraries including tape drives) are known for providing cost effective storage and retrieval of large quantities of data. The data in automated data storage libraries is stored on data storage media (e.g. tape cartridges) that are, in turn, stored in storage slots (or storage shelves or the like) inside the library in a fashion that renders the data storage media, and its resident data, accessible for physical retrieval. An accessor may be used to move data storage media (e.g., tape cartridges) between the storage slots and data storage drives (e.g., tape drives). Such data storage media are commonly termed “removable media.” Data storage media may comprise any type of media on which data may be stored and which may serve as removable media, including but not limited to magnetic media (such as magnetic tape or disks), optical media (such as optical tape or disks), electronic media (such as PROM, EEPROM, flash PROM, Compactflash™, Smartmedia™, Memory Stick™, etc.), or other suitable media. Typically, the data stored in automated data storage libraries is resident on data storage media that is contained within a cartridge and referred to as a data storage media cartridge. An example of a data storage media cartridge that is widely employed in automated data storage libraries for data storage is a tape cartridge.

Sometimes data that is written to the data storage media is encrypted and data that is read from the data storage media is to be decrypted. Encryption may be described as the transformation of data into a form, called a ciphertext, using an encryption key that cannot be easily transformed back to the original data without the decryption key. Decryption may be described as the process of transforming the encrypted data back into its original form using a decryption key.

In some cases, tape drive companies have reason to transfer customer data from one tape cartridge to another tape cartridge. As an example, a customer may send in a damaged tape cartridge and ask the tape drive company to read all the data that can be read from the damaged tape cartridge and to write that data to another tape cartridge. However, the data on the damaged tape cartridge may be encrypted, and the tape drive desires to read any or all available information and write it to another tape cartridge (e.g. a header and an end of tape cartridge marker), but the customer may not want to provide a decryption key for decryption of the encrypted data.

Thus, there is a need in the art for keyless copy of encrypted data.

### SUMMARY OF EMBODIMENTS OF THE INVENTION

Provided are a method, computer program product, and system for copying data. Encrypted data from a first data storage medium is identified. A raw read of encrypted data from the first data storage medium is performed without decrypting the encrypted data and without performing a second encryption of the encrypted data. A raw write of the encrypted data to a second data storage medium is performed without again encrypting the encrypted data.

### BRIEF DESCRIPTION OF THE DRAWINGS

Referring now to the drawings in which like reference numbers represent corresponding parts throughout:

FIG. 1 illustrates details of a computing architecture in accordance with certain embodiments.

FIG. 2 illustrates logic performed by a data storage drive to copy data from a previously written and encrypted data storage medium to another in accordance with certain embodiments.

FIG. 3 illustrates a system architecture that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

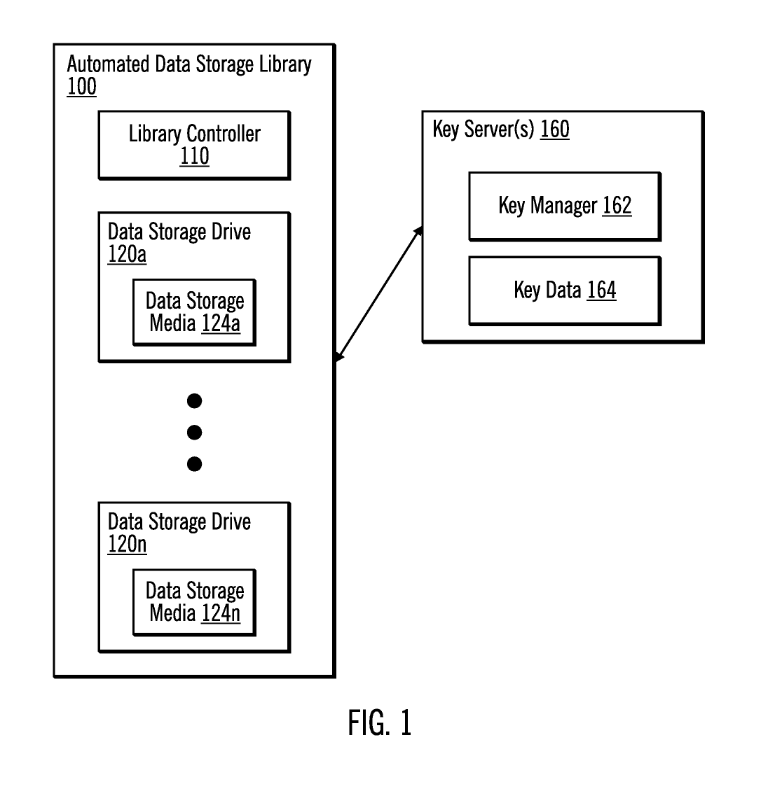

FIG. 1 illustrates details of a computing architecture in accordance with certain embodiments. An automated data storage library 100 includes a library controller 110, one or more data storage drives 120a . . . 120n (e.g. tape drives), and media inserted into those data storage drives 120a . . . 120n, such as data storage media 124a . . . 124n. Each data storage drive 120a . . . 120n is loaded with data storage media 124a . . . 124n (e.g. tape cartridges). It is to be understood that the use of ellipses and suffixes of “a” and “n” after a reference number (e.g. 124a . . . 124n) in the diagram indicates that fewer or more elements than those shown may be used without departing from the scope of embodiments. The one or more data storage drives 120a . . . 120n enable reading information from and writing information to data storage media 124a . . . 124n. Also, the data storage drives are encryption-enabled data storage drives (i.e. they are able to encrypt data that is stored on data storage media 124a . . . 124n and decrypt encrypted data that is read from the data storage media 124a . . . 124n). In certain embodiments, the data storage drives 120a . . . 120n are tape drives that move tape cartridges, as well as enable reading information to and writing information from those tape cartridges. The data storage drives 120a . . . 120n may be grouped into one or more data storage drive pools (not shown). For example, the data storage drive pools may be tape drive pools, and each tape drive pool includes a subset of the tape drives in the automated data storage library 100.

The automated data storage library 100 is also connected to one or more key servers 160. Although the automated data storage library 100 is illustrated as being directly connected to the one or more key servers 160, the automated data storage library 100 may be connected to proxy servers (not shown) that are connected to the one or more key servers 160. A proxy server may be described as a server that receives requests intended for another computing device (e.g. another server or appliance) and that acts on behalf of the requestor (as the requestors' proxy) to obtain the requested service. In embodiments using proxy servers, the proxy servers may act as proxies for the data storage drives 120a . . . 120n and/or data storage drive pools. A proxy server may also be described as a conduit that also acts as a protocol converter and adds other functionality (e.g. Internet Protocol (IP) routing). Thus there may be a proxy server between a key server 160 and a data storage drive 120a . . . 120n (or may not), and, if there is, the proxy server acts as a bridge between one type of interface (e.g. Fiber Channel (FC) or RS-422) and another (e.g. IP).

The one or more key servers 160 each include a key manager 162 and key data 164. The key manager 162 assists encryption-enabled data storage drives 120a . . . 120n (e.g. tape drives) in generating, protecting, storing, and maintaining encryption keys that are used to encrypt information being written to, and decrypt information being read from, data storage media 124a . . . 124n (e.g. tape cartridges). The key manager 162 is capable of serving numerous data storage drives 120a . . . 120n, regardless of where those data storage drives 120a . . . 120n reside (e.g. in an automated data storage library 100, connected to mainframe systems through various types of channel connections, or installed in other computing systems.)

The key manager 162 processes key generation or key retrieval requests. In particular, when a data storage drive 120a . . . 120n is to write encrypted data, the data storage drive 120a . . . 120n first requests an encryption key from a key server 160. Upon receipt of the request at the key server 160, the key manager 162 generates an encryption key (e.g. an Advanced Encryption Standard (AES) key) and serves the generated encryption key to the data storage drive 120a . . . 120n in two protected forms.

1. As a protected key that is encrypted or wrapped (e.g. using Rivest-Shamir-Adleman (RSA) key pairs). The data storage drive 120a . . . 120n writes one or more protected keys to one or more non-volatile areas within the data storage media 124a . . . 124n. In certain embodiment, a non-volatile area is a data storage leader (i.e. the front part of a data storage medium 124a . . . 124n, before the area that user data is stored). In certain embodiments, the protected key may also be referred to as an Externally Encrypted Data Key (EEDK).

2. As a separately encrypted key for secure transfer to and only readable by the data storage drive 120a . . . 120n where it is decrypted upon arrival and used to encrypt the data being written to data storage media 124a . . . 124n. Once the data storage drive 120a . . . 120n encrypts data with this key and is instructed to unload this data storage medium 124a . . . 124n, this key is removed front access, usage by or retrieval from the data storage drive 120a . . . 120n.

When an encrypted data storage medium 124a . . . 124n is to be read, the data storage drive 120a . . . 120n sends the protected key read from the data storage medium 124a . . . 124n to the key manager 162, along with the request to retrieve the key needed to read the data storage medium 124a . . . 124n. The key manager 162 unwraps (decrypts) the wrapped (protected) key to access the secret key and then rewraps (encrypts) this secret key with another key for secure data transfer back to the data storage drive 120a . . . 120n (only readable by the data storage drive 120a . . . 120n), where the rewrapped key is then unwrapped to access the secret key, which is used to decrypt the data stored on the data storage medium 124a . . . 124n. The key manager 162 allows protected keys to be re-encrypted using different keys (e.g. different RSA keys) from the original ones that were used. The key data 164 may be described as a key store of keys used to create (encrypt) or unwrap (decrypt) the protected key. Also, the key data 164 may be described as including version information, an identifier of the proper keys to use in interpreting key data, and the encrypted encryption keys (which are also referred to as protected keys).

Multiple key servers 160 with key managers 162 may be provided to enable high availability (i.e. if one key server 160 is unavailable, another may be used by a data storage drive 120a . . . 120n).

In certain embodiments, the automated data storage library 100 is a tape library that includes tape drives into which tape cartridges may be inserted.

In certain embodiments, a direct key model is implemented. With the direct key model, an application that writes data provides keys to the data storage drives 120a . . . 120n in either a wrapped or direct (key only) manner. The application is not shown in FIG. 1, but would be connected to one or more of data storage drives 120a . . . 120n.

Embodiments enable creation of a data storage format and associated data storage drive operation that enables a low overhead data transfer from one encrypted data storage medium 124a . . . 124n to another, without decrypting the data being transferred and without having the associated keys for decryption.

Formatted records may include encrypted records (i.e. those encrypted with a secret key), records encrypted with well-known keys (also referred to herein as “well-known key encrypted” records) or unencrypted records. For ease of reference, records encrypted with a secret key will be referred to herein as “encrypted” records. For ease of reference, the term “plain records” will be used herein as including both records encrypted with well-known keys and unencrypted records. Also, the plain records may be said to be written “in the effective clear” (i.e. written such that the data is not written encrypted with a key that prevents it from being read without that key (i.e. the data may be written unencrypted or encrypted with a well known key (e.g. the Zero key))). Data that is written “in the effective clear” refers to data that does not need to be encrypted, but that may be encrypted. Because the data itself does not need to be encrypted, any well-known key (e.g. a “zero key”) or now key at all may be used to write the data, without any concern that the key is known or that the data may be read. In certain embodiments, the key may be a key made publicly available. Thus, data that is in the effective clear may be described as data that may be written unencrypted or encrypted with a well known key.

In certain embodiments, the data storage format enables storage of encrypted, well-known key encrypted, and/or unencrypted records on the same data storage medium 124a . . . 124n and is self-describing. An example of such a data storage format is a Self Describing Heterogeneous (SDH) format. “Heterogeneous” may be described as indicating that encrypted, well-known key encrypted, and unencrypted records may be freely intermixed and stored to the data storage medium 124a . . . 124n. The term “freely” may be described as without having to align to dataset boundaries or any restriction along those lines that might require recording of encryption related information in Data Set Information Tables (DSITs) (that may be described as a data storage media logical format area associated with one or more records that contain description information about those records). “Self-describing” may be described as indicating that which records are encrypted and which are plain (i.e. either well-known key encrypted or unencrypted) is determinable from the data stream itself. In certain embodiments, an indicator (e.g. a binary flag) indicates whether the data on the data storage medium 124a . . . 124n is in SDH format or not.

The SDH format allows transfer of encrypted data. The SDH encrypted format is self-describing with respect to whether given records are encrypted or not. This is done by use of a key identifier field per record. As an example, if the key identifier is Zeroes, it means the data was encrypted with a well-known key, the Zero key, and is thus in the effective clear. For the Self Describing Heterogeneous (SDH) format, associated metadata may include referenced protected keys, as well as, corresponding key signatures to insure that the correct keys may be verified before use.

With embodiments, the data storage drive 120a . . . 120n enables reading of data in encrypted form, which is sometimes known as a raw read. Also, the data storage drive 120a . . . 120n enables writing of data as it is received (previously encrypted or not), which is sometimes known as a raw write. The data storage drive 120a . . . 120n enables reading of metadata (from the data storage medium 124a . . . 124n being read) that is needed to allow a successful read of the raw written data storage medium 124a . . . 124n, which will be referred to herein as a metadata read. The data storage drive 120a . . . 120n enables writing of metadata (to the data storage medium 124a . . . 124n being raw written), which enables a successful read of the raw written tape, and this will be referred to herein as metadata write.

In certain embodiments, data compression is done before encryption because encrypted data is not compressible. Encrypted records are thus both compressed and encrypted, and cannot be decompressed when read out in a keyless raw read.

Plain records may or may not be decompressed, depending on both the data storage format, and what is done by the data storage drive 120a . . . 120n as part of a raw read. In certain embodiments, the plain records are encrypted with a well-known key, such as a Zero key, so that these records are effectively not encrypted (i.e. are in the effective clear), because they may be decrypted without knowing any secret key. With plain records that are actually encrypted in this manner, in some embodiments, decryption is performed with the well-known key (and then any necessary decompression is performed) so that the record is restored to clear text (i.e. the clear text case), while in other embodiments, the record is left both compressed and encrypted with the well-known key when doing a raw read (i.e. the trivially encrypted case).

In certain embodiments, the plain records are written without any form of encryption, such that they are read out (and then any necessary decompression is performed) clear text.

Any operation performed in the raw read (e.g. decryption with a well-known key or decompression) is reversed when it is raw written to result in the same encrypted record stream on the second data storage medium 124a . . . 124n. A raw read of an encrypted record bypasses the decryption and any subsequent decompression. In certain embodiments, a raw read of a plain record also bypasses the decryption and any subsequent decompression, but this has different effects: 1) if the record was Zero Key encrypted, then the record stays encrypted; 2) if the record was not encrypted, but was compressed, then the record stays compressed (since decompression was bypassed).

In certain other embodiments, the data storage drive 120a . . . 120n performs a selective raw read based on whether the record was encrypted or plain, which is to say that the data storage drive 120a . . . 120n treats the two cases differently. As an example, for a raw read, decryption and decompression of encrypted records are bypassed, while any necessary decryption (e.g. with a well-known key) and any necessary decompression of plain records are performed so that the records are returned to clear text. With this selective raw read embodiment, the data storage drive 120a . . . 120n is able to perform different operations on different types of input by determining which records are encrypted and which records are plain.

A raw write of an encrypted record bypasses compression and encryption. If the raw read returned clear text, then any formatting which was undone (e.g. decompression), is redone (e.g. compression). With the selective raw read embodiment, there is a corresponding raw write embodiment in which selected records are reformatted (e.g. clear text ones) while others are not (e.g. encrypted records because they were not deformatted).

In certain embodiments, the raw read and raw write treat all records identically, whether encrypted or plain.

In certain embodiments, the raw read and raw write treat these two cases differently. If they opt to handle them differently, in certain embodiments, they may use a technique to determine which records are encrypted or a notification technique during raw reads when the encryption characteristics of records change, while in other embodiments in which the data storage media 124a . . . 124n use the Self-Describing Heterogeneous format, the raw read and raw write are able to identify which records are encrypted and which are plain based on understanding the SDH format. Thus, in certain embodiments, the SDH format is used on the data storage media 124a . . . 124n and all records pass through the same formatting steps (i.e. plain records are encrypted with a well-known key). The data storage drive 120a . . . 120n is able to access an indicator on the data storage medium 124a . . . 124n that indicates whether any data is encrypted on the data storage medium 124a . . . 124n. Additionally, the data storage drive 120a . . . 120n is able to access a key identifier field per record (which is part of the SDH format) to determine whether a given record is encrypted or plain. Then, the data storage drive 120a . . . 120n, for a read, decrypts the encrypted records with the secret key and decrypts with the zero key any plain records that had been encrypted with the zero key.

In certain embodiments, encrypted records are processed one way and unencrypted records another. In particular, encrypted records are encrypted and unencrypted records are not. In this case, the records themselves are not distinguishable from one another. Then, a raw read and raw write operate one way on encrypted records and another on unencrypted records if the unencrypted records are to be rendered clear text. As an example, encrypted records are not decompressed, but unencrypted records are decompressed.

In yet other embodiments, the plain records are encrypted with a well-known key, but the encrypted and plain records are treated differently in raw write and raw read (e.g. read causing decryption of all plain records with the well-known key).

In further embodiments, the plain records are not encrypted, and records are treated differently based on whether they are encrypted or not. The encrypted records and unencrypted records are treated the same in raw read and raw write, which means bypassing both compression and encryption related transforms. The data storage drive 120a . . . 120n performing the raw write recreates any metadata used to enable a regular read to occur. In such embodiments, since records are treated differently, if the data storage drive 120a . . . 120n is not able to distinguish encrypted and plain records (as the SDH format is not used), metadata associated with whether a given record, or range of records are encrypted or not, is stored.

With embodiments in which the data storage media 124a . . . 124n are in the SDH format, keyless copy of a mix of encrypted and plain data does not need to transfer per record or per record range metadata.

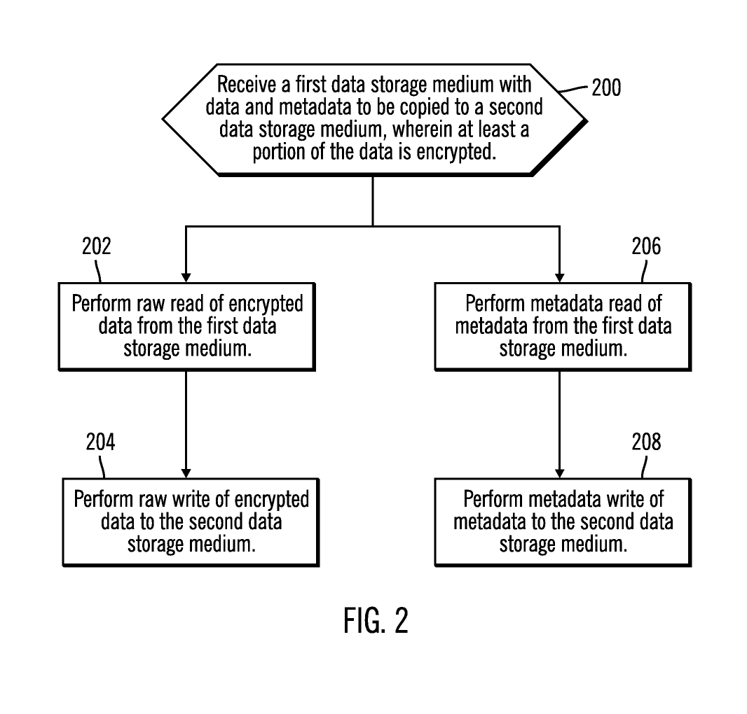

FIG. 2 illustrates logic performed by a data storage drive 120a . . . 120n to copy data from a previously written and encrypted data storage medium 124a . . . 124n to another in accordance with certain embodiments. Control begins at block 200 with the data storage drive 120a . . . 120n receiving a first data storage medium 124a . . . 124n with data and metadata to be copied to a second data storage medium 124a . . . 124n, wherein at least a portion of the data on the first data storage medium 124a . . . 124n is encrypted. In certain embodiments, the data on the first data storage medium is in the SDH format. The second data storage medium 124a . . . 124n may be blank or may be overwritten from the beginning. In block 202, the data storage drive 120a . . . 120n performs a raw read of encrypted data from the first data storage medium 124a . . . 124n. This data may be read on a per record basis. The information read with the raw read includes, for example, filemarks and formatted records. Filemarks may be described as tape format elements that may be used to delineate records and are well known relating to tape drives. Filemarks are essentially null records that do not contain any user data, but are instead used as markers to delineate things such as headers, trailers, and other boundaries. There are special commands available that allow seeking to the next (or last) filemark (or to the next sequence of two sequential filemarks, etc.) skipping any standard records on the way there. In block 204, the data storage drive 120a . . . 120n performs raw write of encrypted data to the second data storage medium 124a . . . 124n. That is, the filemarks and formatted records are written to the second data storage medium 124a . . . 124n.

In block 206, the data storage drive 120a . . . 120n performs a metadata read of metadata from the first data storage medium 124a . . . 124n. In certain embodiments, the metadata may be on a per data storage medium 124a . . . 124n basis and a single metadata read is performed. Alternatively, the metadata may be on a per record, per record range or per key change basis and the metadata read may be performed multiple times (i.e. as many time as there are records on a data storage medium 124a . . . 124n).

In block 208, the data storage drive 120a . . . 120n performs a metadata write of the metadata to the second data storage medium 124a . . . 124n. In certain embodiments, the metadata may be on a per data storage medium 124a . . . 124n basis and a single metadata write is performed. Alternatively, the metadata may be on a per record bases or per record range basis, and the metadata write may be performed multiple times (i.e. as many time as there are records on a data storage medium 124a . . . 124n).

With the logic of FIG. 2, the raw read of data precedes the raw write of that data, and the metadata read of data precedes the metadata write of that data. In light of this, the ordering of the raw read, raw write, metadata read, and metadata write may vary without departing from the scope of the embodiments. For example, the following orders are within the scope of the embodiments:

1. raw read, raw write, metadata read, metadata write

2. raw read, metadata read, raw write, metadata write

3. raw read, metadata read, metadata write, raw write

2. metadata read, metadata write, raw read, raw write

3. metadata read, raw read, metadata write, raw write

4. metadata read, raw read, raw write, metadata write

Thus, embodiments allow the transfer of encrypted data without using the encryption key that was used to encrypt the data. That is, encrypted data is read in encrypted form, and then written in encrypted form (i.e. without encrypting the data a second time). In addition to transferring the encrypted data, embodiments transfer associated metadata.

Embodiments are applicable to either a direct key model (in which case keys are stored externally (e.g. in the key server) and are transferred to the data storage drive) or a wrapped key model (in which keys are stored to data storage media in wrapped key form (EEDK).

Embodiments are also applicable to two or more stand alone drives, without an automated data storage library.

### Additional Embodiment Details

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g. hard disk drives, floppy disks, tape, etc), volatile and non-volatile memory devices (e.g. a random access memory (RAM), DRAMs, SRAMs, a read-only memory (ROM), PROMs, EEPROMs, Flash Memory, firmware, programmable logic, etc.). Current examples of optical disks include compact disk-read only memory (CD-ROM), compact disk-read/write (CD-R/W) and DVD.

The code implementing the described operations may further be implemented in hardware logic (e.g. an integrated circuit chip, Programmable Gate Array (PGA), Application Specific Integrated Circuit (ASIC), etc.). Still further, the code implementing the described operations may be implemented in “transmission signals”, where transmission signals may propagate through space or through transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain implementations may be directed to a method for deploying computing infrastructure by a person or automated processing integrating computer-readable code into a computing system, wherein the code in combination with the computing system is enabled to perform the operations of the described implementations.

The logic of FIG. 2 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIG. 2 may be implemented in software, hardware, programmable and non-programmable gate array logic or in some combination of hardware, software, or gate array logic.

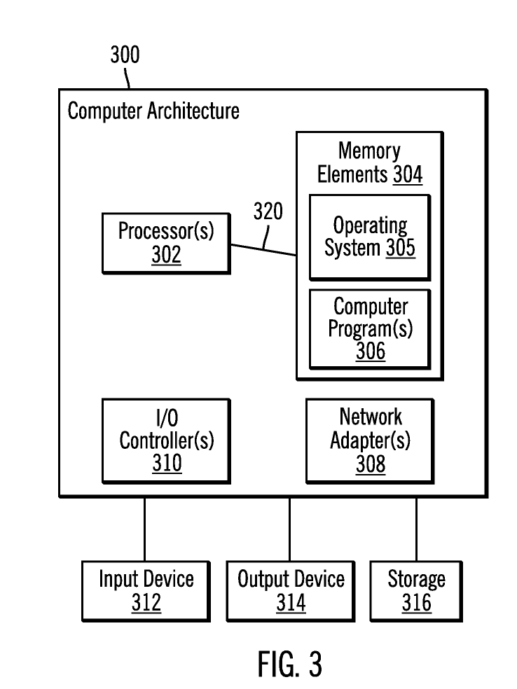

FIG. 3 illustrates a system architecture 300 that may be used in accordance with certain embodiments. Automated data storage library 100 and/or one or more key servers 160 may implement system architecture 300. The system architecture 300 is suitable for storing and/or executing program code and includes at least one processor 302 coupled directly or indirectly to memory elements 304 through a system bus 320. The memory elements 304 may include local memory employed during actual execution of the program code, bulk storage, and cache memories which provide temporary storage of at least some program code in order to reduce the number of times code must be retrieved from bulk storage during execution. The memory elements 304 include an operating system 305 and one or more computer programs 306.

Input/Output (I/O) devices 312, 314 (including but not limited to keyboards, displays, pointing devices, etc.) may be coupled to the system either directly or through intervening I/O controllers 310.

Network adapters 308 may also be coupled to the system to enable the data processing system to become coupled to other data processing systems or remote printers or storage devices through intervening private or public networks. Modems, cable modem and Ethernet cards are just a few of the currently available types of network adapters 308.

The system architecture 300 may be coupled to storage 316 (e.g. a non-volatile storage area, such as magnetic disk drives, optical disk drives, a tape drive, etc.). The storage 316 may comprise an internal storage device or an attached or network accessible storage. Computer programs 306 in storage 316 may be loaded into the memory elements 304 and executed by a processor 302 in a manner known in the art.

The system architecture 300 may include fewer components than illustrated, additional components not illustrated herein, or some combination of the components illustrated and additional components. The system architecture 300 may comprise any computing device known in the art, such as a mainframe, server, personal computer, workstation, laptop, handheld computer, telephony device, appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer-implemented method for copying data, comprising;
identifying encrypted data from a first data storage medium;
performing a raw read of encrypted data from the first data storage medium without decrypting the encrypted data and without performing a second encryption of the encrypted data; and
performing a raw write of the encrypted data to a second data storage medium without again encrypting the encrypted data.

2. The method of claim 1, further comprising:
identifying metadata from the first data storage medium, wherein the first data storage medium includes data and metadata;
performing a metadata read of metadata from the first data storage medium; and
performing a metadata write of the metadata to the second data storage medium.

3. The method of claim 1, wherein the data on the first data storage medium is in a Self Describing Heterogeneous (SDH) format.

4. The method of claim 3, wherein the Self Describing Heterogeneous (SDH) format includes a key identifier field per record that indicates whether the record is encrypted.

5. The method of claim 4, further comprising:
performing the raw read of the encrypted data using the key identifier field to identify encrypted records.

6. The method of claim 1, wherein the first data storage medium includes at least two of encrypted data that is encrypted with a secret key, well-known key encrypted data, and unencrypted data.

7. The method of claim 6, wherein for the well-known key encrypted data, further comprising:
performing the raw read by reading the well-known key encrypted data without decrypting the data, without performing the second encryption of the encrypted data, and without decompressing the data; and
performing the raw write by writing the well-known key encrypted data without compressing the data and without encrypting the data.

8. The method of claim 6, wherein for the well-known key encrypted data, further comprising:
performing the raw read by decrypting the well-known key encrypted data with the well known key and decompressing the decrypted data; and
performing the raw write by compressing the decrypted data and encrypting the compressed data with the well known key.

9. The method of claim 1, wherein the metadata is associated with one or more records on the first data storage medium data.

10. The method of claim 1, wherein the metadata is associated with one or more groups of records on the first data storage medium data.

11. The method of claim 1, wherein the metadata is one of encrypted, well-known key encrypted or unencrypted.

12. A computer program product comprising a computer useable medium including a computer readable program, wherein the computer readable program when executed on a computer causes the computer to:
identify encrypted data from a first data storage medium;
perform a raw read of encrypted data from the first data storage medium without decrypting the encrypted data and without performing a second encryption of the encrypted data; and
perform a raw write of the encrypted data to a second data storage medium without again encrypting the encrypted data.

13. The computer program product of claim 12, wherein the computer readable program when executed on a computer causes the computer to:
identity metadata from the first data storage medium, wherein the first data storage medium includes data and metadata;
perform a metadata read of metadata from the first data storage medium; and
perform a metadata write of the metadata to the second data storage medium.

14. The computer program product of claim 12, wherein the data on the first data storage medium is in a Self Describing Heterogeneous (SDH) format.

15. The computer program product of claim 14, wherein the Self Describing Heterogeneous (SDH) format includes a key identifier field per record that indicates whether the record is encrypted.

16. The computer program product of claim 15, wherein the computer readable program when executed on a computer causes the computer to:
perform the raw read of the encrypted data using the key identifier field to identify encrypted records.

17. The computer program product of claim 12, wherein the first data storage medium includes at least two of encrypted data that is encrypted with a secret key, well-known key encrypted data, and unencrypted data.

18. The computer program product of claim 17, wherein for the well-known key encrypted data, the computer readable program when executed on a computer causes the computer to:
perform the raw read by reading the well-known key encrypted data without decrypting the data, without performing the second encryption of the encrypted data, and without decompressing the data; and
perform the raw write by writing the well-known key encrypted data without compressing the data and without encrypting the data.

19. The computer program product of claim 17, wherein for the well-known key encrypted data, the computer readable program when executed on a computer causes the computer to:
perform the raw read by decrypting the well-known key encrypted data with the well known key and decompressing the decrypted data; and
perform the raw write by compressing the decrypted data and encrypting the compressed data with the well known key.

20. The computer program product of claim 12, wherein the metadata is associated with one or more records on the first data storage medium data.

21. The computer program product of claim 12, wherein the metadata is associated with one or more groups of records on the first data storage medium data.

22. The computer program product of claim 12, wherein the metadata is one of encrypted, well-known key encrypted or unencrypted.

23. A system for copying data, comprising:
a data storage drive including logic capable of performing operations, the operations comprising:
identifying encrypted data from a first data storage medium;
performing a raw read of encrypted data from the first data storage medium without decrypting the encrypted data and without performing a second encryption of the encrypted data; and
performing a raw write of the encrypted data to a second data storage medium without again encrypting the encrypted data.

24. The system of claim 23, wherein the operations further comprise:
identifying metadata from the first data storage medium, wherein the first data storage medium includes data and metadata;
performing a metadata read of metadata from the first data storage medium; and
performing a metadata write of the metadata to the second data storage medium.

25. The system of claim 23, wherein the data on the first data storage medium is in a Self Describing Heterogeneous (SDH) format.

26. The system of claim 25, wherein the Self Describing Heterogeneous (SDH) format includes a key identifier field per record that indicates whether the record is encrypted.

27. The system of claim 26, wherein the operations further comprise:
performing the raw read of the encrypted data using the key identifier field to identify encrypted records.

28. The system of claim 23, wherein the first data storage medium includes at least two of encrypted data that is encrypted with a secret key, well-known key encrypted data, and unencrypted data.

29. The system of claim 28, wherein for the well-known key encrypted data, the operations further comprise:
performing the raw read by reading the well-known key encrypted data without decrypting the data, without performing the second encryption of the encrypted data, and without decompressing the data; and
performing the raw write by writing the well-known key encrypted data without compressing the data and without encrypting the data.

30. The system of claim 28, wherein for the well-known key encrypted data, the operations further comprise:
performing the raw read by decrypting the well-known key encrypted data with the well known key and decompressing the decrypted data; and
performing the raw write by compressing the decrypted data and encrypting the compressed data with the well known key.

31. The system of claim 23, wherein the metadata is associated with one or more records on the first data storage medium data.

32. The system of claim 23, wherein the metadata is associated with one or more groups of records on the first data storage medium data.

33. The system of claim 23, wherein the metadata is one of encrypted, well-known key encrypted or unencrypted.

34. The system of claim 23, wherein the system comprises a tape library including at least one tape drive, wherein the data storage drive comprises a tape drive in the tape library, wherein the first data storage medium comprises a first tape cartridge, and wherein the second data storage medium comprises a second tape cartridge.
